(19) United States
(12) Patent Application Publication
(10) Pub. No.: US 2010/0307897 A1
(43) Pub. Date: Dec. 9, 2010

(54) ELECTRIC SWITCH UNIT

(76) Inventor: Benjamin Keith Marsh, Bowden (AU)

Correspondence Address: Vista IP Law Group LLP, 2040 MAIN STREET, Suite 710, IRVINE, CA, 92614, US

(21) Appl. No.: 12/742,324

(22) PCT Filed: Nov. 12, 2008
(86) PCT No.: PCT/AU2008/001671

§ 371 Date: Aug. 26, 2010

(30) Foreign Application Priority Data
Nov. 12, 2007 (AU) 2007906197

(51) Int. Cl. H01H 9/04

(52) U.S. Cl. 200/302.1

(57) ABSTRACT

Disclosed is a switch unit for use with a face plate. The switch unit has a seal connected thereto to facilitate the installation of the switch unit, as well as subsequent reorientation of the switch unit with respect to the face plate. In one form, the seal is connected to a top surface of a dolly housing of the switch unit. Also disclosed is a frame for removably retaining the switch unit to the face plate.

### TECHNICAL FIELD

The present invention relates to an electric switch unit.

### PRIORITY CLAIM

The present application claims priority from Australian Provisional Patent Application No. 2007906197 entitled “Electric Switch Unit”, filed on 12 Nov. 2007.

The entire content of this document is hereby incorporated by reference.

### INCORPORATION BY REFERENCE

The following documents are referred to in the present application:
Australian Patent Application no. 77437/98 entitled “Improved Electrical Switch”;
Australian Patent No. 781435 entitled “Improvements In and Relating to A Domestic Electrical Switch”.

The entire content of each of these applications is hereby incorporated by reference.

### BACKGROUND

Electric switch units are modular units having a housing containing various parts of a switch, including switching contacts and a dolly.

These switch units can be used in many applications, and are particularly useful for use in conjunction with a switch face plate. Such arrangements are used in nearly all domestic and industrial buildings.

The arrangement includes a switch unit with a dolly, being fixed to an inner surface of the face plate, with the dolly being received in an aperture of the face plate. The arrangement is then installed into a wall with the switch unit behind the face plate and wall, and the dolly of the switch unit accessible to a user, through the aperture, to allow actuation of a light or other load connected to the switch.

Face plates are provided in a number of different configurations, with some intended to be installed in a vertical orientation within a wall, and others in a horizontal configuration. It is useful for the installer to be able to orient the switch unit accordingly, on site.

When installing such arrangements, particularly when a large number of units must be installed, any features that facilitate the convenience of installation can be a great advantage.

### SUMMARY

According to one aspect of the present invention, there is provided a dolly housing for a switch unit, the dolly housing having a top surface for abutment against a face plate, wherein the top surface of the dolly housing has a seal connected thereto.

In one form, the seal is integrally formed with the top surface.

In one form, the dolly housing is connected to a switch mechanism to form the switch unit.

In one form, the dolly housing is made from a flame retardant filled polypropylene.

In one form, the seal is made from a thermoplastic elastomer.

In one form, the dolly housing and the seal are co-injected.

According to a second aspect of the present invention, there is provided a face plate/switch unit combination comprising:
a switch unit; and
a face plate comprising at least one aperture for receiving a part of the switch unit; the switch unit having a dolly housed within a dolly housing and the dolly housing having a seal connected thereto, wherein the switch unit is held in compressed abutment against an inner surface of the face plate by way of a frame.

In one form, the frame defines a circular aperture in which a part of the switch unit is received.

In one form, the switch unit is able to be rotated within the frame to adjust an orientation of the switch unit with respect to the face plate.

In one form, the face plate comprises a plurality of apertures and a plurality of corresponding switch units.

In one form, the face plate comprises a further aperture for receiving a power socket.

In one form, the face plate comprises a further aperture for receiving a data socket.

According to a third aspect of the present invention, there is provided a switch unit comprising a switch mechanism and a dolly housing, the dolly housing comprising a top surface for abutment against a face plate, wherein the top surface of the dolly housing has a seal connected thereto.

In one form, the seal is integrally formed with the top surface.

In one form, the dolly housing is made from a flame retardant filled polypropylene.

In one form, the seal is made from a thermoplastic elastomer.

In one form, the dolly housing and the seal are co-injected.

According to a fourth aspect of the present invention, there is provided a method of forming a face plate/switch unit combination, the method comprising:
abutting the switch unit against the face plate, the switch unit comprising a seal connected to a top surface of the switch unit for abutment against the face plate; and
applying a force to the switch unit to bias the switch unit towards the faceplate.

In one form, the step of applying the force to the switch unit is performed by tightening one or more screws of a frame in operational contact with the switch unit.

According to a fifth aspect of the present invention, there is provided a method of changing an orientation of a switch unit with respect to a face plate, the method comprising:
reducing a compression force applied to the switch unit comprising a seal connected thereto, towards an inner surface of the face plate by a frame;
reorienting the switch unit within the frame; and
increasing the compression force applied to the switch unit towards the inner surface of the face plate by the frame.

In one form, the steps of reducing and increasing the compression force is performed by loosening and tightening one or more screws of the frame.

According to a sixth aspect of the present invention, there is provided a method of forming a dolly housing, the method comprising:
moulding a main body of the dolly housing; and
co-injecting a seal on a top surface of the main body.

According to a seventh aspect of the present invention, there is provided a switch unit for abutment against an inner surface of a face plate, wherein a top surface of the switch unit has a seal connected thereto.

In one form, the top surface of the switch unit is provided by a dolly housing of the switch unit.

### BRIEF DESCRIPTION OF THE DRAWINGS

The various aspects of the present invention will now be described in detail with reference to the following drawings in which:

FIG. 1A—shows a typical face plate for use with various aspects of the present invention;

FIG. 1B—shows a variation of the face plate of FIG. 1A;

FIG. 2—shows an example of the structure of a typical switch unit for use with the various aspects of the present invention;

FIG. 3A—shows a plan view of a switch unit installed in a face plate;

FIG. 3B—shows a side elevation view of the switch unit installed in the face plate;

FIG. 3C—shows an end elevation view of the switch unit installed in the face plate;

FIG. 3D—shows an iso-metric perspective view of the switch unit installed in the face plate;

FIG. 4—shows a dolly housing according to one aspect of the present invention;

FIG. 5—shows an exploded view of a switch unit using the dolly housing of FIG. 4;

FIG. 6—shows the assembled switch unit of FIG. 5 being connected to a face plate;

FIG. 7—shows the assembly of 2 switch units;

FIG. 8—shows the assembly of 4 switch units;

FIG. 9—shows the reorientation of a switch unit;

FIG. 10A—shows a plan view of a face plate/switch unit combination with a 2-gang face plate;

FIG. 10B—shows a side elevation view of the face plate/switch unit combination of FIG. 10A;

FIG. 10C—shows an end elevation view of the face plate/switch unit combination of FIG. 10A;

FIG. 10D—shows an iso-metric perspective view of the face plate/switch unit combination of FIG. 10A;

FIG. 11A—shows a plan view of a face plate/switch unit combination with a power socket;

FIG. 11B—shows a side elevation view of the face plate/switch unit combination of FIG. 11A;

FIG. 11C—shows an end elevation view of the face plate/switch unit combination of FIG. 11A;

FIG. 11D—shows an iso-metric perspective view of the face plate/switch unit combination of FIG. 11A;

FIG. 12A—shows a plan view of a face plate/switch unit combination with 2 power sockets;

FIG. 12B—shows a side elevation view of the face plate/switch unit combination of FIG. 12A;

FIG. 12C—shows an end elevation view of the face plate/switch unit combination of FIG. 12A; and

FIG. 12D—shows an iso-metric perspective view of the face plate/switch unit combination of FIG. 12A.

### DETAILED DESCRIPTION

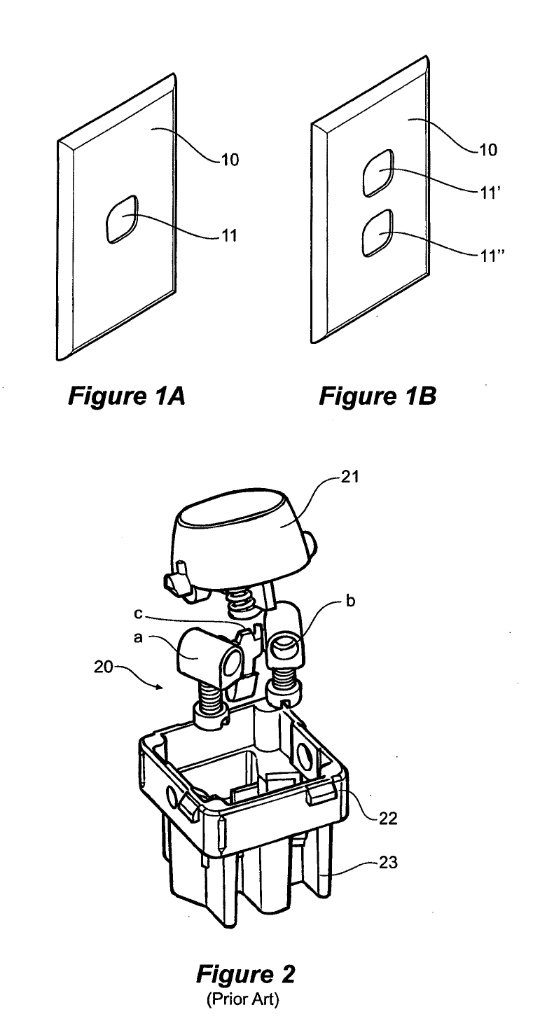

FIGS. 1A and 1B show typical examples of a face plate for use with one or more of the various aspects of the present invention. FIG. 1A shows a face plate 10 with an aperture 11 for receiving a dolly of a switch unit as will be described in more detail below. Face plate 10 may take on any suitable shape as will be understood by the person skilled in the art.

FIG. 1B shows a 2-gang version of the face plate of FIG. 1A. In this version, face plate 10 has two apertures 11′ and 11″ for receiving one each of respective dollys of two switch units.

FIG. 2 shows an example of a typical switch unit 20. Switch unit 20 has a main body or mech housing 23, a dolly 21 and a dolly housing 22. Inside mech housing 23 are the various electrical components making up the switch. Shown in FIG. 2 are electrical terminals a and b, and bridge c. In use, dolly 21 causes bridge c to switch between terminal a and terminal b to connect and disconnect a pathway for electric current, as will be understood by the person skilled in the art. Again, switch mechanisms may take on many forms, and the form shown here is but one example. The switch unit shown here is described in more detail in Australian Patent Application no. 77437/98 entitled “Improved Electrical Switch”, previously incorporated by reference. Another example of a switch unit is as descried in Australian Patent No. 781435 entitled “Improvements In and Relating to A Domestic Electrical Switch”, also previously incorporated by reference.

It will also be understood that in some variations, switch unit 20 has separate dolly housing 22 and mech housing 23, which are then assembled either at manufacture or upon installation, or at any other convenient time. As shown here, dolly housing 22 and mech housing 23 can be formed integral to each other.

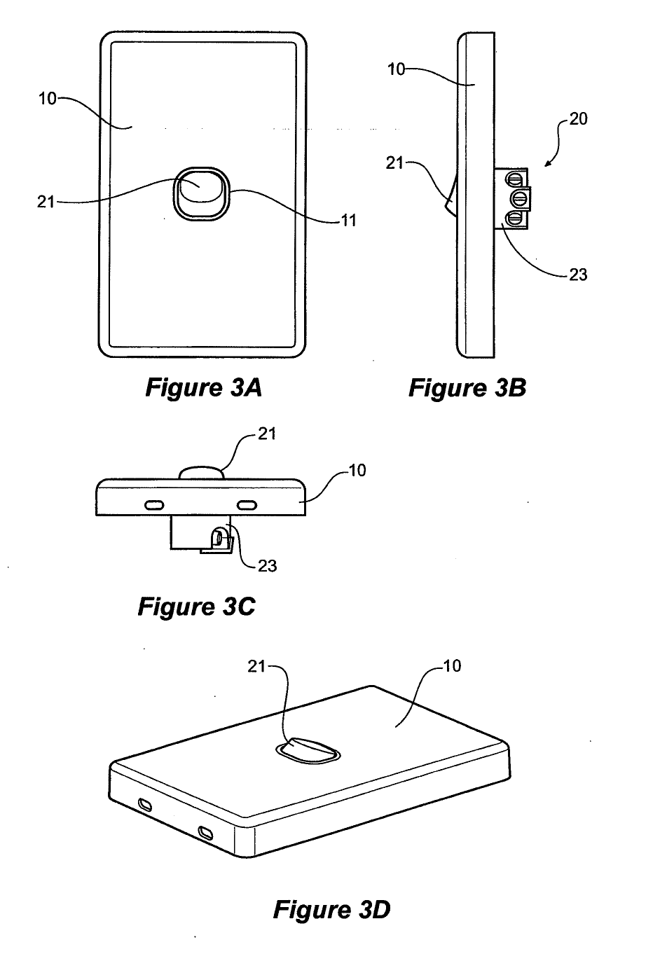

FIGS. 3A to 3D show the arrangement when switch unit 20 is combined with face plate 10. The plan view of FIG. 3A shows face plate 10 with dolly 21 of switch unit 20, received in aperture 11. The side elevation view of FIG. 3B also shows dolly 21 received in the aperture of face plate 10 with the mech housing 23 of switch unit 20 visible from the side. In this view, the dolly housing 23 is hidden behind the side lip of face plate 10. FIG. 3C shows the end elevation view, while FIG. 3D shows an iso-metric perspective view.

In many environments, it is desirable to provide some sealing between the switch unit and the face plate, to prevent ingress of contaminants such as dust and/or the ingress of water, which could affect the operation and safety of the switch.

This seal is provided by a rubber or gasket which upon installation, is placed between the switch unit and the rear surface of the face plate at the contact face of the switch unit 20 and face plate 10.

According to one aspect of the present invention, this seal is provided already connected to the switch unit or dolly housing, and in one further form, as an integral component of the switch unit or the dolly housing.

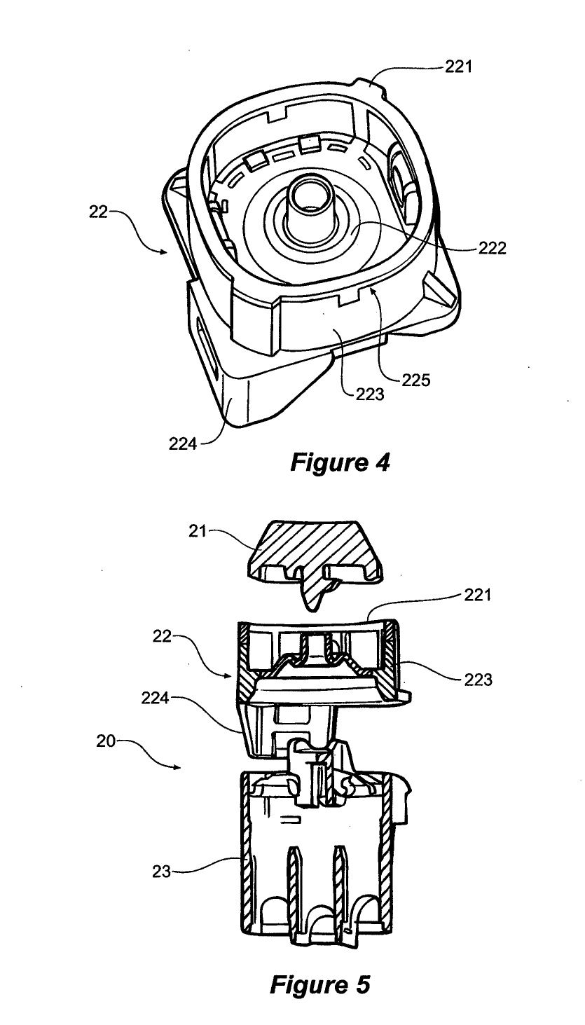

FIG. 4 shows dolly housing 22 with a main wall 223 having a top surface 225. Dolly housing 22 also has a lower wall 224 for use in connecting to a mech housing (not shown) to provide a full switch unit 20 (not shown). Of course, it will be appreciated that this particular configuration is an example only, and many different configurations may be used.

In this aspect of the present invention, a seal or gasket 221 is connected to the dolly housing, and in this particular example, is integrally formed on the top surface 225 of the main body of dolly housing 22. Seal 221 may be made from any suitable material as known to the person skilled in the art. In one form, the material is a thermoplastic elastomer (TPE) such as Thermolast K-TC6FRA provided by Kraiburg TPE GmbH & Co KG in Germany. The dolly housing 22 may also be made from any suitable material, including flame retardant filled polypropylene such as Dynacom PP 704 available from Dynachem & Co LTD, Taipei, Taiwan ROC.

In this example, an optional further seal or gasket 222 may be provided inside the dolly housing 22, but other dolly housings may have no additional seal or gasket.

FIG. 5 shows a cross-sectional and exploded view of a switch unit 20 using the dolly housing 22 according to this aspect of the present invention. Shown there is mech housing 23 for connection to dolly housing 22, which in turn will receive dolly 21. Dolly housing 22 has on its main wall 223, seal 221 integrally formed therewith.

In one form, dolly housing 22 is made by co-injection moulding using for example, a Hwa Chin DC210 co-injection moulding machine. In one example, the process involves injecting Dynacomp PP-704 Natural into the tool for the primary operation. The tool is then rotated in the machine and Kraiburg Thermolast K TC6FRN Natural is injected into the tool for the secondary operation. After cooling, the finished component is then ejected from the tool. The entire process takes approximately 50 seconds. There are two tools, 1× single cavity (backup tool) and 1×2 cavity injection moulding production tool. The material is processed in accordance with the manufacturer's specifications.

It will also be understood that the term “connected” as used in this specification is not limited to the seal being formed with the dolly housing or switch unit during manufacture, but could otherwise be connected thereto as a separate part by, for example, gluing, friction fitting or pressing into a channel, adhering, or otherwise fixing to the dolly housing or switch unit. The seal may even be removable, as long as the seal is able to be retained by the dolly housing or switch unit during installation. Having the seal or gasket so connected will facilitate both the installation process as well as a reorientation or rotation process.

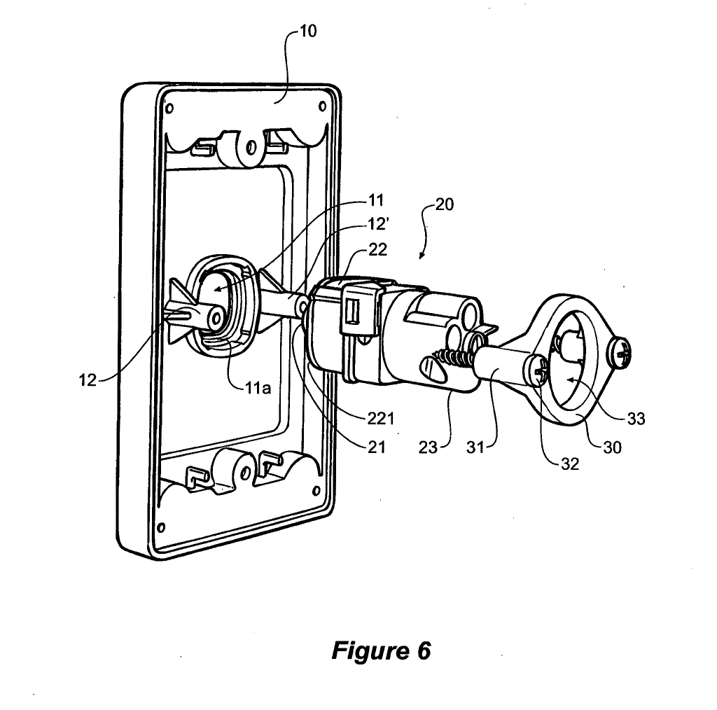

FIG. 6 shows an assembled version of the switch unit 20 of FIG. 5 being connected to a face plate 10. Switch unit 20 is made up of dolly housing 22, dolly 21 (just visible in this view) and mech housing 23. Switch unit 20 is being positioned so that dolly 21 can be inserted into aperture 11 of face plate 10. In positioning, the top surface of the dolly housing 22 is placed in abutment against the face plate. It will be understood that the term “abutment against” does not necessarily require physical contact between the top surface and the face plate, but also allows for an element to be sandwiched or compressed there between, such as the seal or gasket 221.

In some forms, aperture 11 may be surrounded by ribs 11a to facilitate a good contact between face plate 10 and switch unit 20, and particularly, with seal 221. Seal 221 can be seen integrally formed with dolly housing of switch unit 20. The association of the switch unit 20 and the face plate 10 forms a face plate/switch unit combination.

Also shown in FIG. 6 is frame 30 with screw posts 31 with respective screws 32. Frame 30 defines frame aperture 33, to receive switch unit 20 and operationally connect thereto.

In use, once switch unit 20 is positioned in place against face plate 10, frame 30 is slid over switch unit 20 and secured to face plate 10 by tightening screws 32 which are received in corresponding posts 12 and 12′ of face plate 10. This provides a bias force towards the face plate. The tightening of screws 31 ensure a tight seal between seal 221 and the rear surface of face plate 10.

Because in this form, the seal 221 and dolly housing 22 are connected and/or integral, the installation process is facilitated because the installer does not need to separately carry, position and/or tighten a seal or gasket. In particular, the positioning and retaining of a seal or gasket in place against the face plate is particularly troublesome when the seal is a separate unit to the dolly housing or switch unit. When the seal or gasket and the dolly housing or switch unit are essentially a single unit, installation is greatly facilitated.

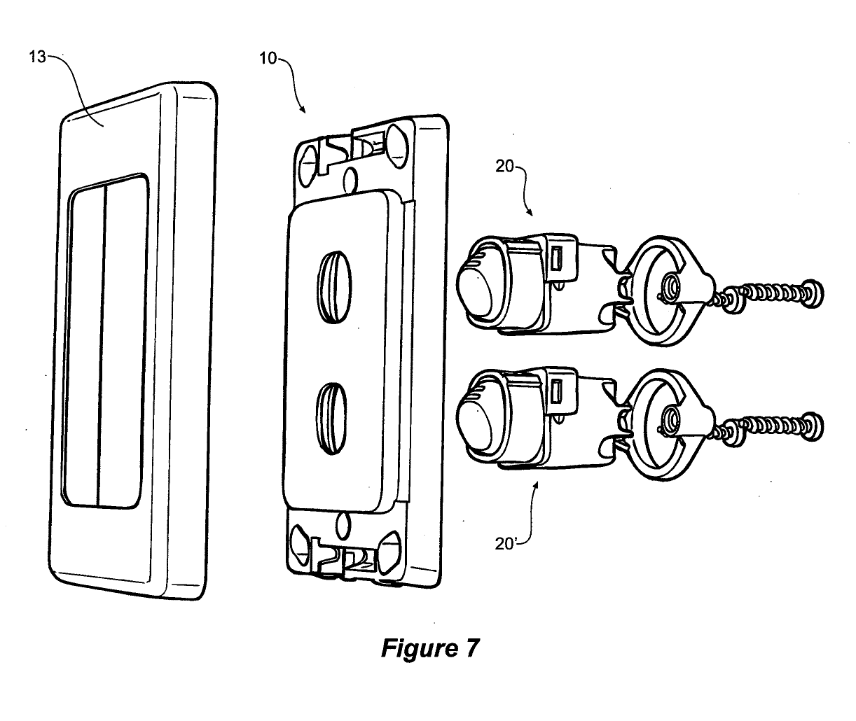

This is particularly beneficial of there are multiple switch units to install, as shown in FIG. 7, showing two switch units 20, 20′ to one face plate 10 and FIG. 8, showing 4 switch units 20, 20′, 20″ and 20′″ to one face plate 10. This is even more beneficial when an installer must install a plurality of face plates, perhaps each with 4 switch units. In these examples, face plate 10 also has a separate cover plate 13.

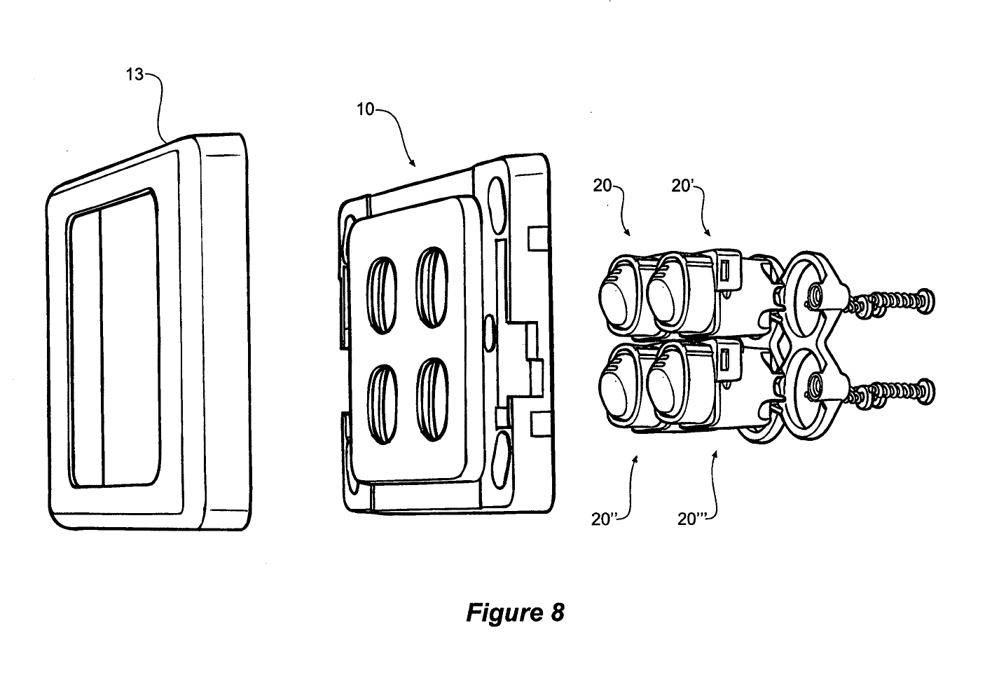

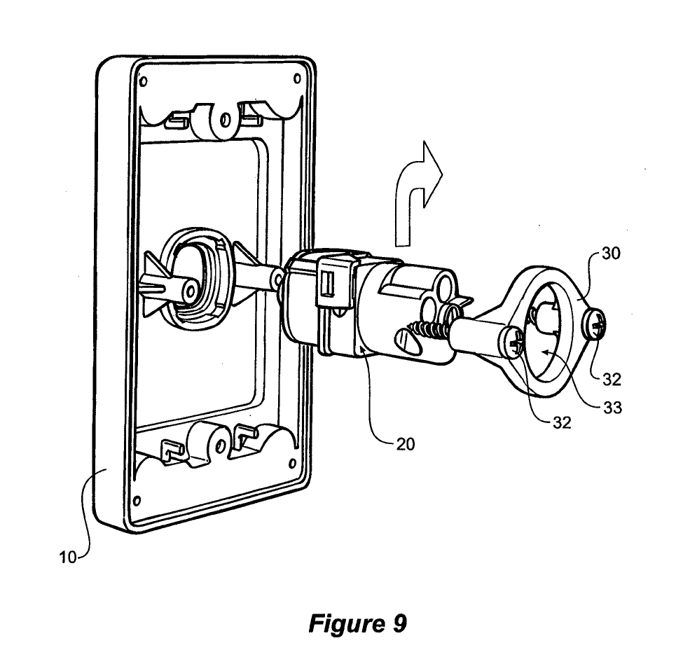

In another form of the invention, this arrangement facilitates the reorientation of switch unit 20 with respect to face plate 10. As shown in FIG. 9, switch unit 20 may be reoriented by 90 degrees or other, by simply loosening screws 32 of frame 30 to allow seal 221 to disengage from its sealing contact with the rear of face plate 10, rotating switch unit 20 within frame aperture 33 (note that mech housing 23 has a circular configuration at least in one part to facilitate rotation with frame aperture 33), re-engaging seal 221 with the rear of face plate 10 and retightening screws 32 to compress switch unit 20 and integral seal 221 into sealing contact with face plate 10.

Again, due to the integral arrangement of seal 221 and switch housing 20 or dolly housing 22, the reorientation process is greatly facilitated as the installer does not have to separately reposition the seal or gasket with respect to both the face plate and the switch unit.

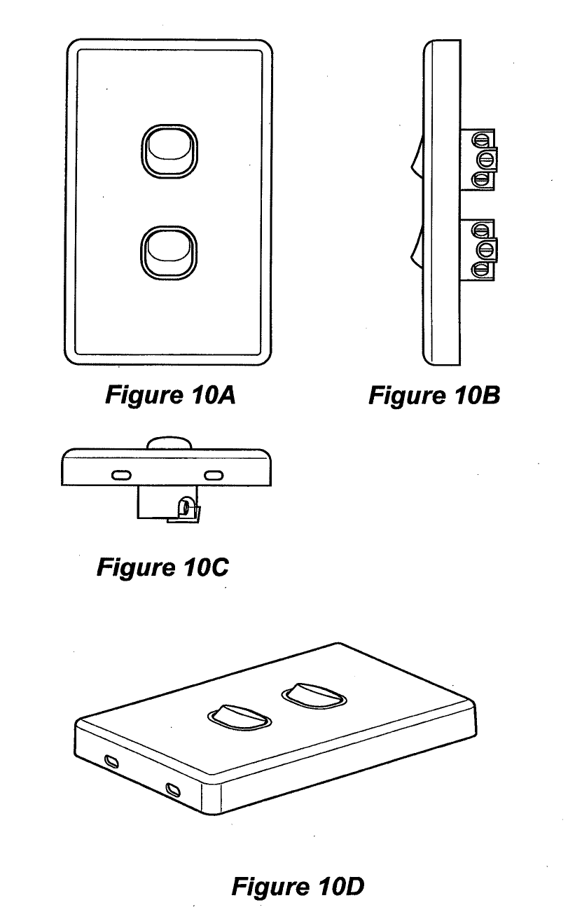

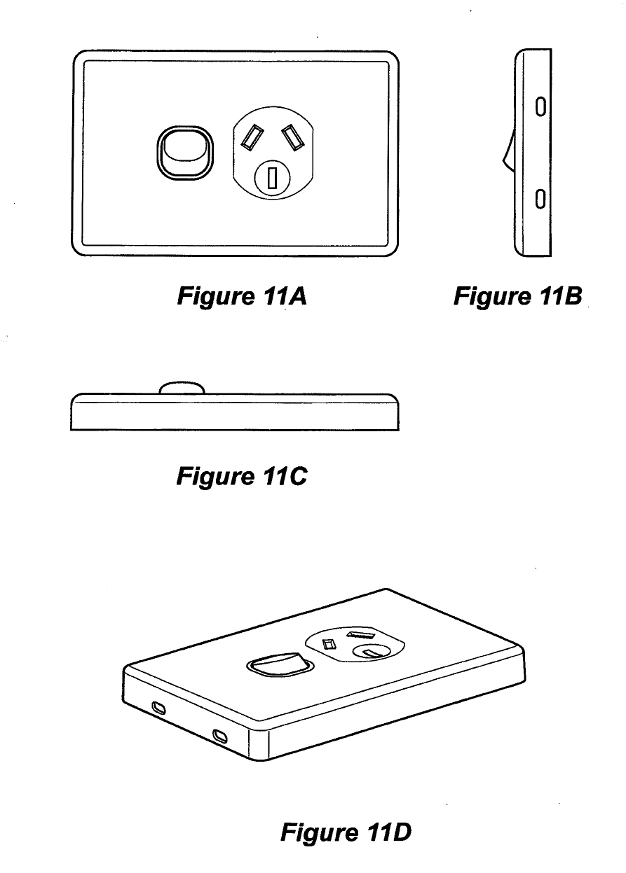

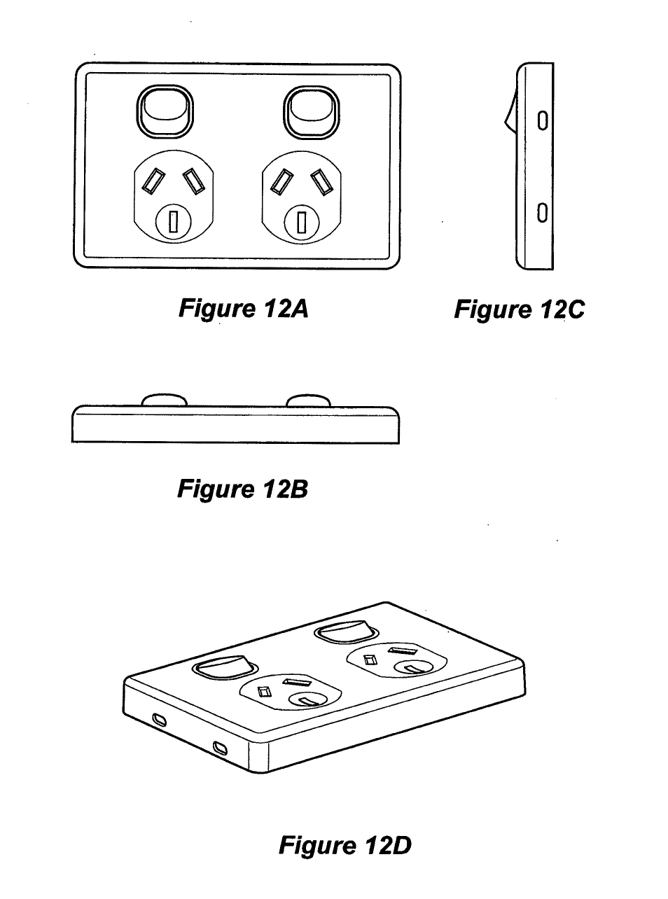

The various aspects of the present invention can be applied to any face plate/switch unit combination. FIGS. 10 to 12 show some non-limiting examples of the variations possible. FIG. 10A shows a plan view of a face plate/switch unit combination with the face plate with two switch units as described in relation to FIG. 7 above. FIG. 10B shows a side elevation view, FIG. 10C shows an end elevation view and FIG. 10D shows an iso-metric perspective view. FIGS. 11A to 11D show plan, side elevation, end elevation and iso-metric perspective views respectively, of a face plate/switch unit combination with the face plate with one switch unit and one power socket; and FIGS. 12A to 12D show plan, side elevation, end elevation and iso-metric perspective views respectively of a face plate/switch unit combination with the face plate with two switch units and two power sockets. Any other form of socket may also be provided, including data sockets.

It will also be appreciated that the integral seal need not always be integrated at the dolly housing, but may be integrated at any part of the switch unit that will make sealing contact with the face plate, such as with an extended lip of the mech housing for example.

It will be understood that the above has been described with reference to particular embodiments and that many variations and modifications may be made within the scopes of the different aspects of the present invention.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

1. A dolly housing for a switch unit, the dolly housing having a top surface for abutment against a face plate, wherein the top surface of the dolly housing has a seal connected thereto.

2. A dolly housing as claimed in claim 1 wherein the seal is integrally formed with the top surface.

3. A dolly housing as claimed in claim 1 wherein the dolly housing is connected to a switch mechanism to form the switch unit.

4. A dolly housing as claimed in claim 3 wherein the dolly housing is made from a flame retardant filled polypropylene.

5. A dolly housing as claimed in claim 3 wherein the seal is made from a thermoplastic elastomer.

6. A dolly housing as claimed in claim 2 wherein the dolly housing and the seal are co-injected.

7. A face plate/switch unit combination comprising:
a switch unit; and
a face plate comprising at least one aperture for receiving a part of the switch unit;
the switch unit having a dolly housed within a dolly housing and the dolly housing having a seal connected thereto, wherein the switch unit is held in compressed abutment against an inner surface of the face plate by way of a frame.

8. A face plate/switch unit combination as claimed in claim 7 wherein the frame defines a circular aperture in which a part of the switch unit is received.

9. A face plate/switch unit combination as claimed in claim 8 wherein the switch unit is able to be rotated within the frame to adjust an orientation of the switch unit with respect to the face plate.

10. A face plate/switch unit combination as claimed in claim 7 wherein the face plate comprises a plurality of apertures and a plurality of corresponding switch units.

11. A face plate/switch unit as claimed in claim 7 wherein the face plate comprises a further aperture for receiving a power socket.

12. A face plate/switch unit as claimed in claim 7 wherein the face plate comprises a further aperture for receiving a data socket.

13. A switch unit comprising a switch mechanism and a dolly housing, the dolly housing comprising a top surface for abutment against a face plate, wherein the top surface of the dolly housing has a seal connected thereto.

14. A switch unit as claimed in claim 13 wherein the seal is integrally formed with the top surface.

15. A switch unit as claimed in claim 13 wherein the dolly housing is made from a flame retardant filled polypropylene.

16. A switch unit as claimed in claim 13 wherein the seal is made from a thermoplastic elastomer.

17. A switch unit as claimed in claim 14 wherein the dolly housing and the seal are co-injected.

18. A method of forming a face plate/switch unit combination, the method comprising:
abutting the switch unit against the face plate, the switch unit comprising a seal connected to a top surface of the switch unit for abutment against the face plate; and
applying a force to the switch unit to bias the switch unit towards the faceplate.

19. A method as claimed in claim 17 wherein the step of applying the force to the switch unit is performed by tightening one or more screws of a frame in operational contact with the switch unit.

20. A method of changing an orientation of a switch unit with respect to a face plate, the method comprising:
reducing a compression force applied to the switch unit towards an inner surface of the face plate by a frame;
reorienting the switch unit within the frame; and
increasing the compression force applied to the switch unit towards the inner surface of the face plate by the frame.

21. A method as claimed in claim 20 wherein the steps of reducing and increasing the compression force is performed by loosening and tightening one or more screws of the frame.

22. A method of forming a dolly housing, the method comprising:
moulding a main body of the dolly housing; and
co-injecting a seal on a top surface of the main body.

23. A switch unit for abutment against an inner surface of a face plate, wherein a top surface of the switch unit has a seal connected thereto.

24. A switch unit as claimed in claim 23 wherein the top surface of the switch unit is provided by a dolly housing of the switch unit.

25. A dolly housing as claimed in claim 2 wherein the dolly housing is connected to a switch mechanism to form the switch unit.
